(19) United States
(12) Patent Application Publication
(10) Pub. No.: US 2016/0134144 A1
(43) Pub. Date: May 12, 2016

(54) PORTABLE POWER CHARGER WITH REMOVABLE RECHARGEABLE INTERNAL BATTERIES

(71) Applicant: Halo2Cloud, Glastonbury, CT (US)

(72) Inventors: Garold C. Miller, Glastonbury, CT (US); Nathan Daniel Weinstein, Glastonbury, CT (US)

(21) Appl. No.: 14/934,319

(22) Filed: Nov. 6, 2015

Related U.S. Application Data
(60) Provisional application No. 62/076,009, filed on Nov. 6, 2014.

(51) Int. Cl. H02J 7/00

(52) U.S. Cl. CPC H02J 7/0045; H02J 7/0021

(57) ABSTRACT

A portable charger unit includes a tray defining a plurality of cavities for receiving removable batteries; a head attached to the tray; a power input port in the head; a power output port in the head; and charging circuitry within the head that interconnects the input port, the output port, and the cavities of the tray. In a first mode of operation the charging circuitry receives input voltage and current from the power input port and delivers internal battery voltage and current to the cavities of the tray, and in a second mode of operation the charging circuitry receives internal battery voltage and current from the cavities of the tray and delivers output voltage and current to the power output port.

### CROSS-REFERENCE RELATED APPLICATIONS

This application is a non-provisional of and claims the benefit of U.S. Provisional Application 62/076,009 filed Nov. 6, 2014, which is incorporated herein by reference.

### BACKGROUND

1. Field of Invention

The present invention generally relates to power chargers for electronic devices, and more particularly relates to a portable charger having removable and separately rechargeable internal batteries.

2. Background of the Invention

Present day consumers typically own several electronic devices specifically designed for portability and on-the-go use, including, for example, a mobile phone or smart phone, a portable music player like an iPod® or an MP3 player, a tablet, a portable gaming unit, a camera, and the like. Each of these devices requires frequent recharging. Such electronic devices typically utilize a cable for connecting the device to a power source, such as a wall outlet, a car charger, an airplane charger, or a computer. However, a separate cable is usually required for each power source. Moreover, different electronic devices often utilize different connection ports and interfaces such that a single charging cable is not compatible with multiple devices. Accordingly, a tech-savvy consumer, with several electronic devices, will usually have multiple charging cables to keep track of. Even then, the consumer may be without sufficient power to recharge a phone due to bad weather or a power outage, or may not always be in a place where a power source is readily available, or even if so, may not have the appropriate cable or adapter available to use with a particular power source.

With traditional power sources, such as those noted above, it is often difficult to charge multiple devices at the same time, especially where each device requires a separate charging cable. For example, a car charger port may only handle a single cable at a time. Adaptor devices are available on the market for connecting multiple devices to a power source at the same time—for example, a two-to-one or three-to-one car charger splitter. However, such adapters are often only compatible with certain interfaces. Moreover, such adapters are separate from portable power sources and tend to be bulky.

Similarly, connection interface attachments are also available for adapting a charging cable for use with a variety of devices for recharging from a power source, each requiring a different interface connection. However, such attachments are usually separate small pieces, and therefore difficult to keep track of when not in use. Further, use of such attachments does not solve the problem presented by the need to charge multiple devices at the same time, from the same power source, as oftentimes, only one attachment can be used with a charging cable at a time.

Portable power chargers exist that permit recharging of electronic devices when a standard power source is not readily available. For example, portable power chargers are illustrated and described in co-pending U.S. application Ser. No. 13/571,992, filed Aug. 10, 2012, and Ser. No. 13/682,985, filed Nov. 21, 2012, which share common inventors with the present application and which are incorporated herein by reference. Some existing power charger devices usually cannot charge multiple devices at the same time, either due to limited capacity or connectivity options. Even if multiple devices may be attached to the power charger at the same time, the charger may prioritize how the devices are recharged—i.e., it will charge one device first and then the second, and so on. However, this approach takes a long time to recharge all devices and risks not having sufficient charge remaining in the charger for fully charging the second device.

Further, some portable charger devices will not permit recharging from the charger when the charger is itself being recharged or connected to an external power source. Such devices require the charger unit to be disconnected from a power source before a charge will be passed on to a device connected to the charger, or require the charger unit to be fully charged first before any device connected to the charger unit can then be recharged. Still further, users typically want to be able to recharge an electronic device immediately, even if just for a small boost in power and do not want to wait until the power charger is recharged. Accordingly, users desire a portable power charger that they can be certain will have a sufficient charge for on-the-go recharging of electronic devices. Thus, it is desirable to have a portable power charger that is itself easy to recharge, either by direct connection to an external power source, when available, or by being able to remove and replace the internal battery source with a new battery that has been fully charged in advance.

Additionally, such portable charger devices typically require a dedicated input port for recharging the internal battery and a separate output port dedicated for recharging electrical devices from the internal battery. More particularly, such charging devices often require multiple output ports for recharging multiple electronic devices at the same time. The addition of extra charging ports compromises the size and design of the charger unit, for example, a unit with a dedicated input port and two or more output ports would need to be larger than a charger unit with just a single port due to the need to properly arrange the electronics for operation of the charger as desired.

In view of the foregoing, there is a need for a charger that can be used to charge a variety of electronic devices, including but not limited to smart phones, mobile phones, data tablets, music players, cameras, camcorders, gaming units, e-books, Bluetooth® headsets and earpieces, GPS devices, and the like, either individually or collectively in various combinations. Additionally, there is a need for such a charger that is portable, has a compact size, and is easy to use in various conditions and locations to charge one or more electronic devices simultaneously, or recharge the internal battery of the charger unit for future on-the-go use, including but not limited to in a house or office, a car or an airplane. Still further, there is a need for a portable charger having a port that can act both as an input port for recharging an internal battery unit in the charger and as an output port for recharging an electronic device connected to the charger. Still further, there is a need for a portable charger that can recharge the internal battery from an external power source (either from an AC power source or a DC power source) at the same time as an electronic device connected to the charger, even while both the external power source and the electronic device are connected to the charger through the same port. Still further, there is a need for a portable charger unit in a compact size that has increased functionality for a user requiring a portable source of power. Accordingly, it is a general object of the present invention to provide a portable charger that improves upon conventional power chargers currently on the market and that overcomes the problems and drawbacks associated with such prior art chargers.

### SUMMARY OF THE INVENTION

In accordance with the present invention, a portable charger is provided for charging one or more electronic devices. In general, a portable charger unit includes an internal rechargeable battery unit for connecting to and recharging one or more electronic device, as necessary, disposed within a charger housing. The charger housing may also include at least one power input connection port for recharging the internal battery unit from an external power source, and at least one power output connection port for connecting the power charger with at least one electronic device in need of a charge. Alternatively, the portable charger may include one or more power connection ports that can act as power inputs, power outputs, or both, so as to be used for recharging the internal battery from an external power source connected to the charger via a connection port, or charge electronic devices connected to the charger via a connection port. The portable charger may further be connected to an external power source and one or more electronic device at the same time, even using the same power connection port, without affecting operation of the charger to receive a charge from the external power source or supply a charge to the electronic devices.

In preferred embodiments of the present invention, the charger housing comprises an inner housing and an outer shell, which is removable from the inner housing to expose one or more battery cavities designed to receive removable rechargeable batteries, preferably rechargeable Lithium Ion batteries. The batteries are snap-fitted into the battery cavities and may easily be removed by a user. Each cavity includes a positive contact (e.g., an electrical contact adapted to engage a projecting positive terminal on a standard cylindrical battery design) and a negative contact (e.g., an electrical spring contact adapted to engage a recessed negative terminal on a standard cylindrical battery design). When the inner housing includes multiple battery cavities, each of the respective terminals of the cavities are interconnected within the inner housing structure to provide or receive an electrical charge. More particularly, the terminals are in operative communication with a controller/processing unit within the charger housing and all input and output connection ports for distributing an electric charge as appropriate when the internal batteries are in place.

The outer shell of the charge housing is placed over the inner housing for use. In this regard, the internal batteries are protected for the elements for easy, on-the-go use of the portable power charger. If the internal batteries need replacing, the outer shell can easily be removed from the inner housing to give the user access to the battery cavities. In preferred embodiments, the charger housing includes a release mechanism for disengaging the outer shell from the inner housing. The connection between the outer shell and the inner housing is preferably a snap-fit connection, and more preferably, hermetically seals the interior of the charger housing.

In another aspect of the present invention, a power indicator or interface is provided on the charger housing to indicate the power capacity level of the internal rechargeable battery units. The power interface can comprise a light or series of lights, a digital readout, or other known forms of indicating power level of a battery. Additional indicator means can be utilized in the present invention for various functionalities, including but not limited to indicating that a charge is being provided to an electronic device, either from a standard power source or the internal battery unit of the portable battery charger, or indicating the power level in an electronic device attached to the charger via the power output connector interface.

In another aspect of the present invention, a separate charger can be provided for recharging the internal batteries separate and apart from the portable charger unit. In this regard, a user can have multiple sets of batteries so that some batteries can be recharged in the separate charger while previously charged batteries are installed within the portable charger unit for on-the-go usage. Indeed, a user can bring extra pre-charged batteries on a trip so that the batteries can be switched out as they die, for example in-the-field, without risk of losing the ability to use the portable charger unit to recharge one or more electronic devices. In accordance with the present invention, the internal batteries may still be recharged from an external power source by connecting the portable charger unit to such a power source, for example, using charging cables and appropriate adapter interfaces.

In a preferred embodiment of the separate charger unit for the rechargeable batteries, a charger housing includes batteries cavities in which batteries are placed for recharging. The charger unit includes a connection interface for connecting to an external power source. For example, a standard AC plug interface can be pivotably attached to the charger housing. When the user needs to plug the charger into a standard U.S. wall socket for recharging the internal battery of the charger, the plug can be pivoted out from its storage cavity so that the charger can be plugged in to the wall socket. Alternatively, a DC power connector, such as a car charger interface, can be storable within a cavity formed into the charger housing and movable from the charger housing to plug the charger into a car charging socket. Similarly, the charger housing can include a connection port (such as a USB port) for connection with an external power source using a charging cable, or output connector interfaces, for example, USB, micro-USB, mini-USB, Apple Lightning™, Apple 30-pin, or the like, can be storable within the charger housing and pulled out of respective storage cavities for use to charge electronic devices using the charger.

These and other objects, features and advantages of the present invention will become apparent in light of the detailed description of embodiments thereof, as illustrated in the accompanying drawings.

### BRIEF DESCRIPTION OF THE DRAWINGS

FIG. 1 shows a front perspective view of a partly assembled portable battery charger in accordance with a first embodiment of the present invention.

FIG. 2 shows a side perspective view of the fully assembled portable battery charger of FIG. 1.

FIG. 3 shows an end view of the portable battery charger of FIG. 1.

FIG. 4 shows a side partly assembled view of the portable battery charger of FIG. 1.

FIG. 5 shows a schematic of internal components of a head portion of the portable battery charger of FIG. 1.

FIG. 6 shows a bottom perspective view of a partly assembled portable battery charger in accordance with a second embodiment of the present invention.

FIG. 7 shows a bottom perspective view of the partly assembled portable battery charger of FIG. 6 with batteries removed.

FIG. 8 shows a top perspective view of the fully assembled portable battery charger of FIG. 6.

FIG. 9 shows a top perspective view of a partly assembled portable battery charger in accordance with a third embodiment of the present invention.

FIG. 10 shows a front perspective view of the partly assembled portable battery charger of FIG. 9.

FIG. 11 shows a front perspective view of the fully assembled portable battery charger of FIG. 9.

FIG. 12 shows a top view of a battery charger for recharging internal batteries of the portable battery chargers of FIGS. 1-11 in accordance with the present invention.

FIG. 13 shows a bottom perspective view of the battery charger of FIG. 12.

### DETAILED DESCRIPTION OF THE DRAWINGS

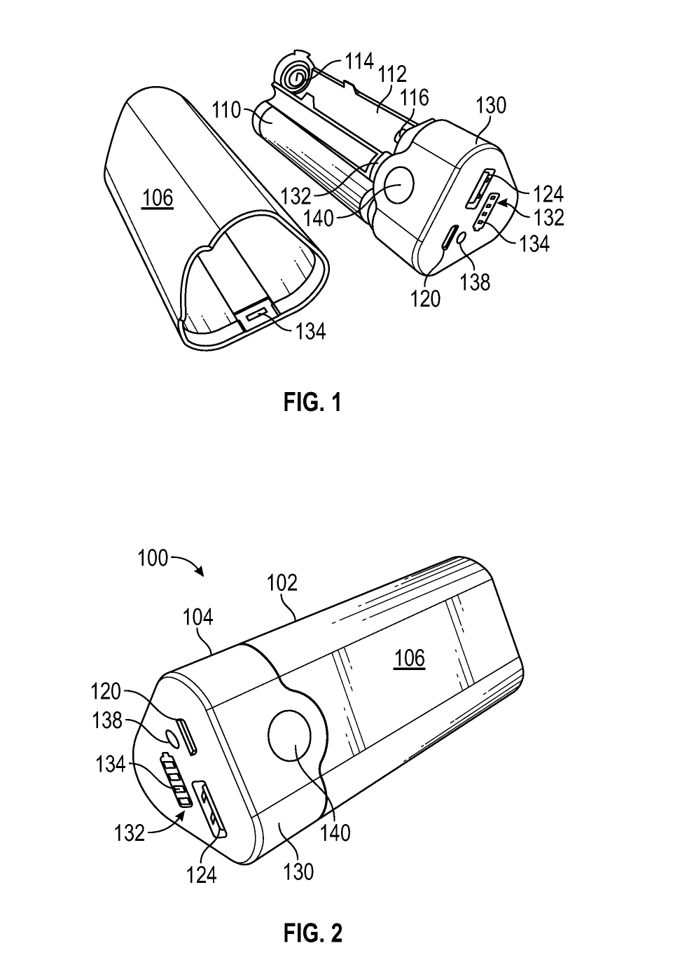

A portable charger 100 in accordance with a first embodiment of the present invention is shown in FIGS. 1-4. As illustrated, the charger 100 comprises a charger housing 102 that is made up of an inner housing or tray 104 and an outer shell 106. In use, the inner housing or tray 104 is disposed within the outer shell 106 to protect the interior of the charger housing 102. Preferably, the outer shell 106 securely fits onto the tray 104, more preferably by snap fitting into place, and even more preferably by hermetically sealing the interior of the charger housing 102 to protect the inner workings thereof from the environment when the charger 100 is in use, such as, for example, in on-the-go activities.

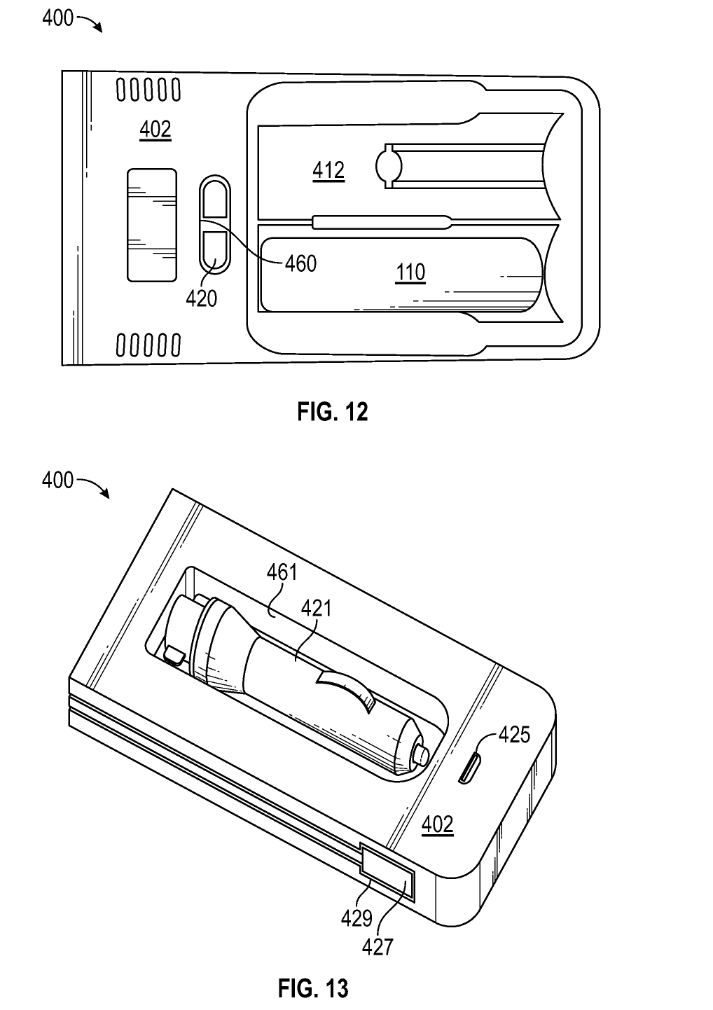

In preferred embodiments of the present invention, the power for the charger unit 100 is provided by rechargeable internal batteries 110. As shown, the batteries 110 are standard cylindrically shaped batteries designed for easy removal from the charger unit 100. Preferably two or more removable batteries are provided in the charger housing 102. More particularly, the batteries 110 are installed into respective battery cavities 112 that are formed in the tray 104. The batteries 110 are preferably Lithium Ion batteries. Alternatively, the batteries 110 may be NiMH (nickel metal hydride) batteries, or any other type of rechargeable battery. Preferably the internal batteries 110 are of relatively high capacity. The batteries 110 can be easily removed from their respective cavities 112 for recharging using a separate charger unit, such as illustrated in FIGS. 11 and 12. In this regard, each of the battery cavities 112 is designed to snugly receive a battery, preferably by snap-fitting the battery into the cavity so that positive and negative terminals of the battery are properly aligned with and engage positive and negative contacts 114, 116.

Referring to FIGS. 1-5, the portable power charger 100 includes a power input connection port 120 (shown as a micro-USB port) for recharging internal batteries via direct connection to an external power source using a standard charging cable. Where multiple internal batteries are used, the inner housing includes electrical input switching means 122 to distribute any charge received via the power input connection port 120 to each of the battery cavities 112, and thus to each of the internal batteries 110 stored therein for recharging.

Similarly, the portable power charge includes a power output connection port 124 (shown as a USB port) for connecting the portable charger unit 100 with one or more electronic devices in need of a charge from the internal batteries 110 of the charger unit. More particularly, a standard charging cable can be connected to the charger unit 100 via the output port 124 to receive a charge from the batteries 110. Where multiple batteries are used, the inner housing includes electrical output switching means 126 to collect a charge from each of the batteries 110 and distribute it to the output port 124. Optionally, the electrical output switching means 126 can be configurable, e.g., by operation of a microprocessor 128, to place some or all of the internal batteries 110 in serial or parallel electrical arrangements, thereby providing for variable output current and/or voltage.

The portable charger concepts described herein can also be used with one or more separate connector cables for connecting the charger unit 100 with an external power source for recharging the internal batteries 110 and/or one or more electronic devices for recharging from the charger unit, as necessary. For example, the electrical input switching means 122 and the electrical output switching means 126 can be configurable to simultaneously charge the internal batteries 110 and also bypass some current from the power input port 120 to the power output port 124—i.e., placing the power output port 124 in parallel to the internal batteries 110.

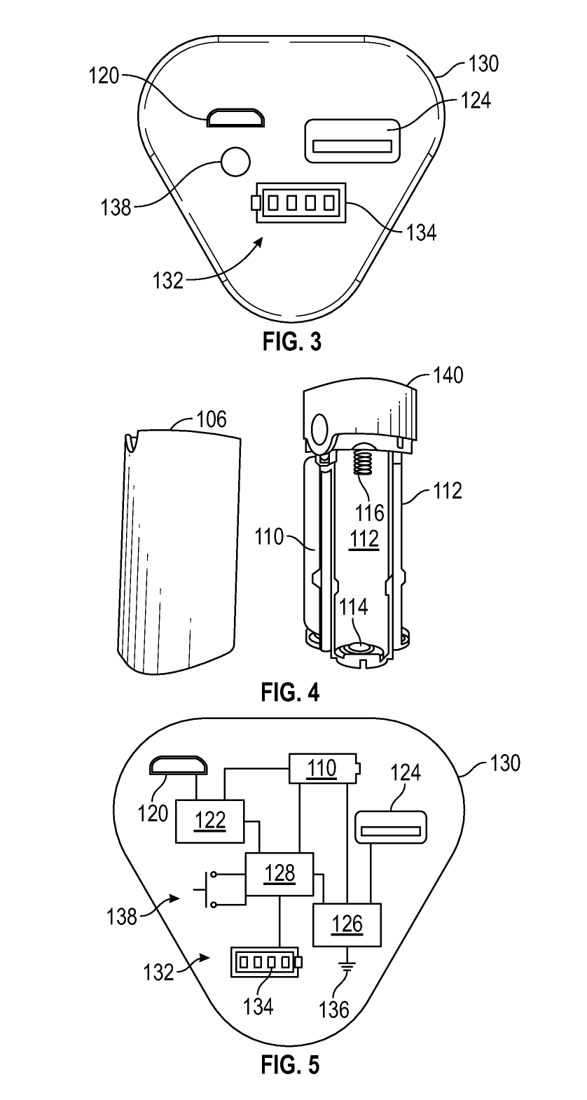

Referring to FIGS. 3 and 4, in addition to the input and output switching means 122, 126 and the microprocessor 128, the portable charger unit also includes within a head portion 130 of the tray 104 a power indicator 132, shown in the form of a battery icon, which loses “bars” 134 as the collective power capacity of the batteries decreases. As discussed below, other forms of a power indicator 132 can be used without departing from the spirit and principles of the present invention.

The charger unit 100 also may include, within the head portion 130, an auxiliary battery 136, which is supplemental to the internal batteries 110. Even when the internal batteries 110 are removed or not charged, the auxiliary battery 136 can provide power to the output port 124 and can be recharged from the input port 120. The auxiliary battery 136 may be Li-Ion, NiMH, or any other type of rechargeable battery. Preferably the auxiliary battery 136 is of relatively high capacity.

A power control button 138 also is provided to turn the portable charger unit 100 on and off as desired for supplying power to the output port 124. In alternative embodiments, automatic power control can be used to preserve the battery capacity when the charger unit is not needed to charge electronic devices.

The portable charger in accordance with the present invention may have a variety of designs, including the embodiments discussed and illustrated herein, and may be provided with connector cables, connection ports, connection interfaces and adapters suitable for recharging the internal battery of the charger unit and recharging the batteries of various electronic devices connected thereto. For example, alternative designs for the portable charger unit are illustrated and described in co-pending U.S. application Ser. No. 13/571,992, filed Aug. 10, 2012; Ser. No. 13/682,985, filed Nov. 21, 2012, Ser. No. 13/800,825, filed Mar. 13, 2013, and Ser. No. 13/833,838, filed Mar. 15, 2013, which share common inventors and ownership with the present application and which are incorporated herein by reference. Such designs as shown in those applications can be provided with the features described herein, including a separable outer shell and inner housing that can be opened to expose removable rechargeable batteries that can be replaced with new, pre-charged batteries for full power capacity, or alternatively kept in the charger housing for recharging from direct connection to an external power source.

Referring to FIGS. 1-5, the tray 104 is adapted to receive three batteries 110, in respective cavities 112 evenly distributed about the circumference of the tray around a central longitudinal axis of the tray. Each cavity 112 includes standard electrical connections for engagement with the positive and negative terminals of the batteries and are sized to snugly receive the batteries to locate and secure them in place without affecting the ease of removing the batteries for replacement and recharging as the user may find necessary.

A release button 140 may be provided for disengaging the outer shell 106 from the inner housing or tray 104. The interior wall of the outer shell 106 may include catches 142 for receiving projections 144 that are formed on the exterior surface of the tray 104. To remove the outer shell 106—e.g., to gain access to the internal batteries 110 for replacement—the user can press the release button 140, which will disengage the catches 142 from the projections 144 in order to allow the tray 104 to be removed from the outer shell 106. When the outer shell 106 is placed back on the inner housing or tray 104, the parts 142, 144 will snap together, with the outer shell 106 completely enclosing the battery cavities 112 and sealing the connection to protect the batteries from the environment, especially useful during intended use of the portable battery charger.

The power charger also includes various electrical components to provide computing operations for the device. The integrated circuitry and other components may comprise a controller and processing unit (e.g., the microprocessor 128), memory (e.g., ROM, RAM, flash), a circuit board, a hard drive, and/or various input/output (I/O) support circuitry.

More particularly, the power charger includes the microprocessor 128, which is configured to execute instructions and to carry out operations associated with the power charger. For example, the processing unit 128 can keep track of the capacity level of the batteries 110 and of the auxiliary battery 136, and/or store data or provide a conduit means by which data can be exchanged between electronic devices, such as between a smart phone and a computer. The processing unit 128 communicates with the batteries 110 to determine how much capacity is remaining in the batteries. Upon determining the capacity level, the processing unit 128 can communicate with the power indicator means 132 to provide the user with information for how much capacity is remaining in the internal rechargeable batteries 110 and whether the charger unit 100 needs to be connected to an external power source for recharging or the batteries 110 need to be removed for recharging and perhaps replaced with new pre-charged batteries. In general, the controller and processing unit 128 is in operative communication with the connections for each of the battery cavities 112 for controlling power in and power out from the batteries 110. Additionally, the controller and processing unit 128 is in operative communication with the power input 120 and the power output 124 of the charger unit.

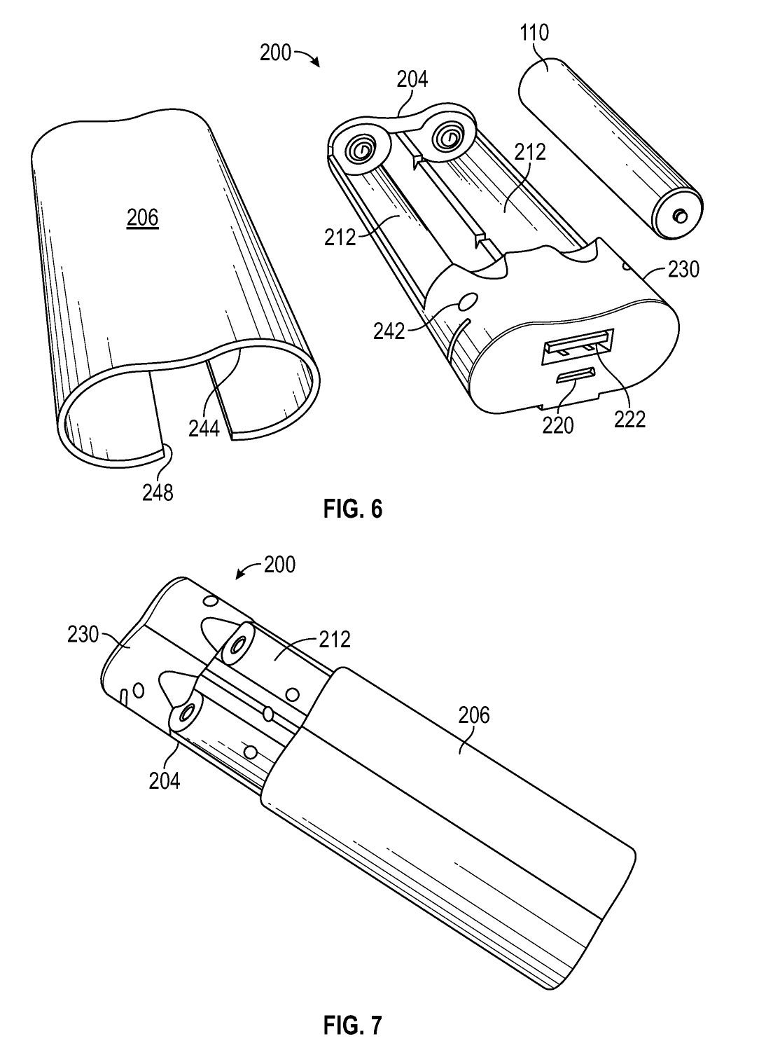

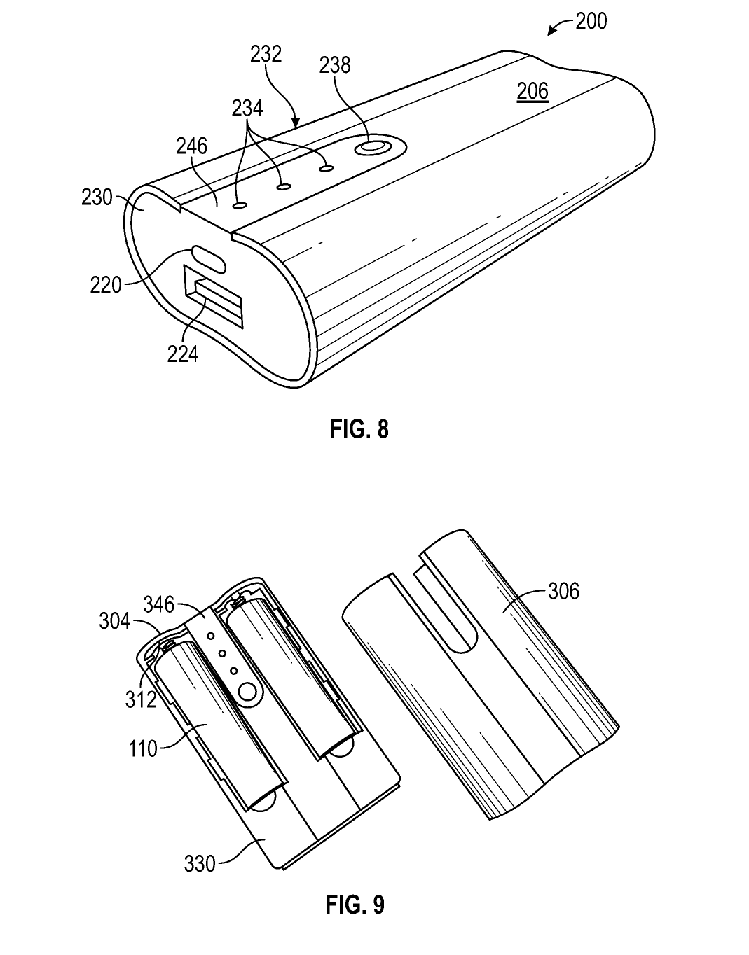

Referring to FIGS. 6-8, a second embodiment of a portable power charger 200 in accordance with the present invention is shown. Components similar to those of the first embodiment are similarly numbered and generally are not described in further detail. The charger 200 includes two batteries 110 that are positioned side-by-side within the inner housing. As with other designs described herein, the batteries 110 are adapted to snap-fit into respective battery cavities 212 while being easily removable therefrom for replacement and recharging. The batteries can still be recharged while sitting in the inner housing or tray 204 via direct connection to an external power source through the power input connection 220, shown as a micro-USB port, although other forms (e.g., coaxial DC plug) can be equally effective. The power from the batteries can be provided to one or more electronic device in need of a charge via the power output connection port 224, shown as a USB port.

The inner housing can include friction projections 242 to engage the outer shell, and to catch indents 244 formed on the interior surface thereof to ensure a secure connection between the two when the charger housing 202 is assembled as intended in order to protect the internal batteries 110 from the environment during use.

The inner tray 204 comprises a raised top panel 246, which provides a grip for removing the tray 204 from the outer shell 206. The raised top panel 246 can snap-fit into a complementary shaped opening 248 that is formed in the top of the outer shell to ensure a secure connection. The top panel 246 also houses a power indicator 232 as well as a power button 238. The power indicator 232 comprises a series of lights 234, provided in the raised top panel 246, which will provide information about the power capacity of the internal batteries during use of the charger unit 200. For example, the lights 234 can change color as the power capacity decreases—e.g., from green to yellow to red. Alternatively, the illuminated lights 234 may decrease in number as the power capacity decreases—e.g., from three to two to one to zero.

The portable power charger unit 200 may also include the power control button 238 for turning the charger unit on and off, i.e., supplying power to the power output port 224, as desired. Still further, or alternatively, the charger unit can use an automatic power control protocol.

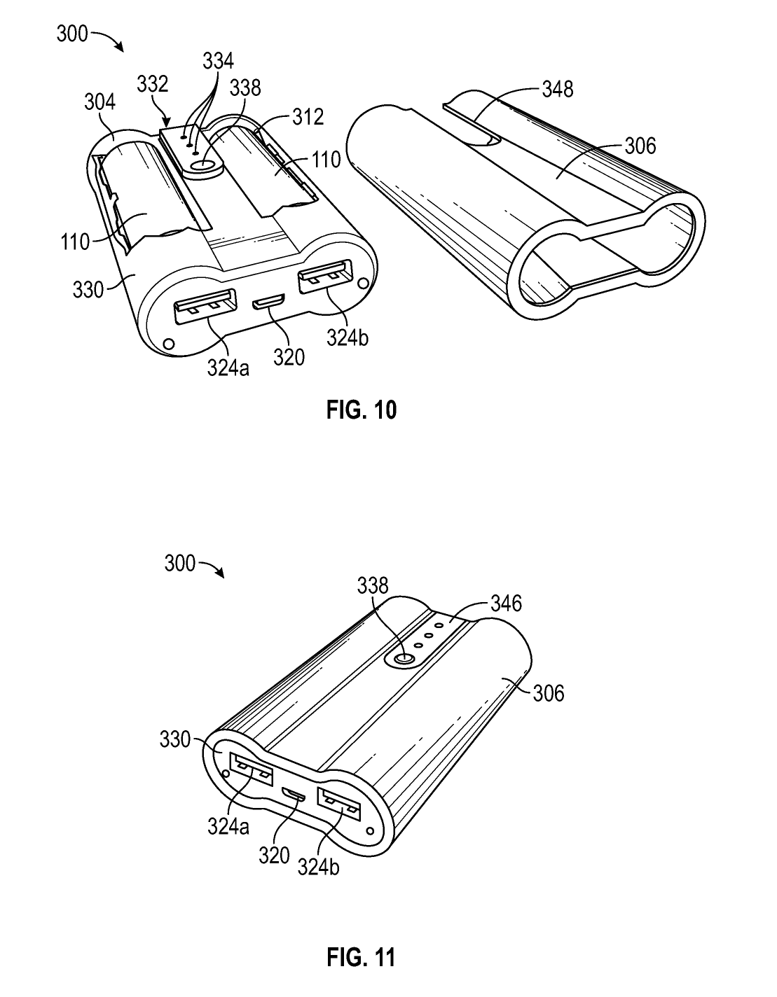

Referring to FIGS. 9-11, another embodiment of a portable power charger unit 300 in accordance with the present invention is shown. Components similar to those of the first or second embodiments are similarly numbered and generally are not described in further detail. As illustrated in FIGS. 9-11, the charger includes two batteries 110 positioned side-by-side within the inner housing or tray 304. As with other designs described herein, the batteries 110 are adapted to snap-fit into respective battery cavities 312 while being easily removable therefrom for replacement and recharging. The batteries 110 can still be recharged while sitting in the tray 304 via direct connection to an external power source through the power input connection 320, shown as a micro-USB port. The power from the batteries 110 can be provided to one or more electronic device in need of a charge via power output connection ports 324a, 324b, shown as two USB ports.

The outer shell 306 can be removed from the inner housing or tray 304 using a raised top panel 346 as a grip. The inner housing or tray 304 can include friction projections to engage the outer shell 306, and to catch indents formed on the interior surface thereof to ensure a secure connection between the two when the charger housing 302 is assembled as intended in order to protect the internal batteries from the environment during use.

The power indicator 332 comprises a series of lights 334 which will provide information about the power capacity of the internal batteries 110 during use of the charger unit. For example, the lights can change color as the power capacity decreases—e.g., from green to yellow to red. Alternatively, the lights may decrease in number as the power capacity decreases—e.g., from three to two to one to zero.

The portable power charger unit 300 may also include a power control button 338 for turning the charger unit on and off as desired. In some embodiments, a separate power control button can be provided for each of the output ports 324a, 324b. Still further, the charger unit can use an automatic power control protocol.

Referring to FIGS. 12-13, a separate charger unit 400 can be provided for recharging the batteries via direct connection to an external power source. As shown, a retractable AC wall plug 420 is included within a cavity 460, indented into the charger housing 402, for plugging the unit 400 into a wall plug for recharging batteries 110 housed therein. In this regard, a user can have multiple sets of batteries so that some batteries can be recharged in the separate charger while previously charged batteries are installed within the portable charger unit for on-the-go usage. Indeed, a user can bring extra pre-charged batteries on a trip so that the batteries can be switched out as they die, for example in-the-field, without risk of losing the ability to use the portable charger unit to recharge one or more electronic devices. In accordance with the present invention, the internal batteries may still be recharged from an external power source by connecting the portable charger unit to such a power source, for example, using charging cables and appropriate adapter interfaces.

In a preferred embodiment of the separate charger unit for the rechargeable batteries, the charger housing 402 includes battery cavities 412 in which batteries are placed for recharging. The charger unit 400 includes a connection interface for connecting to an external power source. For example, a standard AC plug interface 420 can be pivotably attached to the charger housing. When the user needs to plug the charger 400 into a standard U.S. wall socket for recharging the internal battery of the charger, the plug can be pivoted out from its storage cavity 460 so that the charger can be plugged in to the wall socket. Alternatively, a DC power connector 421, such as a car charger interface, can be storable within a cavity 461 formed into the charger housing 402 and movable from the charger housing to plug the charger into a car charging socket. Similarly, the charger housing can include a connection port 425 (such as a USB port) for connection with an external power source using a charging cable, or output connector interfaces, for example, USB, micro-USB, mini-USB, Apple Lightning™, Apple 30-pin, or the like, can be storable within the charger housing and pulled out of respective storage cavities for use to charge electronic devices using the charger.

The foregoing description of embodiments of the present invention has been presented for the purpose of illustration and description. It is not intended to be exhaustive or to limit the invention to the form disclosed. Obvious modifications and variations are possible in light of the above disclosure. The embodiments described were chosen to best illustrate the principles of the invention and practical applications thereof to enable one of ordinary skill in the art to utilize the invention in various embodiments and with various modifications as suited to the particular use contemplated.

What is claimed is:

1. A portable charger unit comprising:
a tray defining a plurality of cavities for receiving removable batteries;
a shell releasably attached to enclose the tray;
a head attached to the tray;
a power input port in the head;
a power output port in the head; and
charging circuitry within the head that interconnects the input port, the output port, and the cavities of the tray,
wherein a first mode of operation of the charging circuitry receives input voltage and current from the power input port and delivers internal battery voltage and current to the cavities of the tray, and
wherein a second mode of operation of the charging circuitry receives internal battery voltage and current from the cavities of the tray and delivers output voltage and current to the power output port.

2. The unit of claim 1 wherein a third mode of operation of the charging circuitry receives input voltage and current from the power input port and delivers internal battery voltage and current to the cavities of the tray and delivers output voltage and current to the power output port.

3. The unit of claim 1 wherein the caivirtes of the tray are cylindrical.

4. The unit of claim 1 wherein the cavities of the tray are rectangular.

5. The unit of claim 1 wherein there are at least three cavities in the tray.

6. The unit of claim 1 wherein the cavities of the tray are arrayed symmetrically about a longitudinal axis of the tray.

7. The unit of claim 1 wherein the shell is attached to the tray by at least one releasable catch.

8. The unit of claim 7 wherein the at least one releasable catch is operable by a release button disposed at the head of the tray.

9. The unit of claim 1 further comprising a power button disposed at the head for activating or deactivating supply of power from the cavities of the tray to the power output port.

10. The unit of claim 1 comprising more than one power output port.

11. The unit of claim 10 further comprising for each power output port a power button disposed at the head for activating and deactivating supply of power from the cavities of the tray to the respective power output port.

12. The unit of claim 1 further comprising an auxiliary battery disposed within the head and interconnected by the charging circuitry with at least the power input port and the power output port.

13. The unit of claim 1 further comprising a battery charge level indicator disposed at the head.

14. The unit of claim 1 further comprising a raised top panel formed on the tray, wherein the raised top panel houses at least one of a power button or a battery charge level indicator.

15. The unit of claim 1 wherein the charging circuitry comprises a microprocessor interconnected to control the delivery of current among the cavities of the tray, the power input port, and the power output port.

16. The unit of claim 1 wherein the power input port has the form of a micro-USB port.

17. The unit of claim 1 wherein the power output port has the form of a USB port.

18. A portable charger unit comprising:
a tray defining a plurality of cavities for receiving removable batteries;
a head attached to the tray;
a power input port in the head;
a power output port in the head; and
charging circuitry within the head that interconnects the input port, the output port, and the cavities of the tray,
wherein a first mode of operation of the charging circuitry receives input voltage and current from the power input port and delivers internal battery voltage and current to the cavities of the tray, and
wherein a second mode of operation of the charging circuitry receives internal battery voltage and current from the cavities of the tray and delivers output voltage and current to the power output port.

19. The unit of claim 18 wherein a third mode of operation of the charging circuitry receives input voltage and current from the power input port and delivers internal battery voltage and current to the cavities of the tray and delivers output voltage and current to the power output port.

20. The unit of claim 18 further comprising a power button disposed at the head for activating or deactivating supply of power from the cavities of the tray to the power output port.
